(19) United States
(12) Patent Application Publication
(10) Pub. No.: US 2010/0127940 A1
(43) Pub. Date: May 27, 2010

(54) ANTENNA DEVICE, RADIO COMMUNICATION EQUIPMENT, SURFACE-MOUNTED ANTENNA, PRINTED CIRCUIT BOARD, AND MANUFACTURING METHOD OF THE SURFACE-MOUNTED ANTENNA AND THE PRINTED CIRCUIT BOARD

(75) Inventors: Yasumasa HARIHARA, Tokyo (JP); Toshihiro Tsuru, Tokyo (JP)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: TDK Corporation, Tokyo (JP)

(21) Appl. No.: 12/623,911

(22) Filed: Nov. 23, 2009

(30) Foreign Application Priority Data
Nov. 26, 2008 (JP) 2008-300903

(51) Int. Cl. H01Q 1/38; H01P 11/00

(52) U.S. Cl. 343/700 MS; 29/600

(57) ABSTRACT

An antenna device has a substrate having a power supply line, and a surface-mounted multiple-resonance antenna having a base and a conductor pattern formed on the base and provided on the substrate, wherein the conductor pattern includes two antenna conductor patterns and a plane conductor pattern which connects each of the antenna conductor patterns and the power supply line, the plane conductor pattern 16 includes a slit which controls the connection distance between at least a portion of each of the antenna conductor patterns and the power supply line, and the substrate does not have a conductor pattern in a region corresponding to the slit.

### TECHNICAL FIELD

The present invention relates to an antenna device, radio communication equipment, a surface-mounted antenna, a printed circuit board, and a manufacturing method of the surface-mounted antenna and the printed circuit board.

### BACKGROUND OF THE INVENTION

In recent years, compact communication terminal devices such as cellular phones which solely cope with plural radio communication systems using a surface-mounted inverted-F antenna, such as wireless LAN, GPS, and Bluetooth®, have appeared. The frequencies of electric waves used by these radio communication systems are typically different from each other. Plural surface-mounted antennas are provided in one compact mobile terminal device, which cannot make the compact communication terminal device smaller. The study for coping with the plural radio communication systems of different frequencies by one surface-mounted antenna is being advanced.

One of the candidates of such surface-mounted antennas which are now being studied is a multiple-resonance antenna. This has plural radiation electrodes whose lengths and widths are different from each other on one base surface and supplies power from one power supply line to all the radiation electrodes. Its specific example is shown in FIGS. 1, 4, 6, and 8 of Japanese Patent No. 3319268.

### SUMMARY OF THE INVENTION

In the multiple-resonance antenna described in Japanese Patent No. 3319268, capacitance power supply having a gap between the power supply line and the radiation electrode is adopted. The characteristic of the resonance antenna responds to the length and width of the gap very sensitively. Therefore, if the manufacturing accuracy of the gap is low, the manufacturing variation in impedance is increased. Additionally, an electric field concentrates on the gap portion, therefore the resonance antenna is susceptible to an outside influence.

There, it is considered to let the power supply method be direct power supply. But, the direct power supply causes another problem that the impedance matching between the resonance antennas becomes difficult. This will be described below in detail.

The impedance matching between the resonance antennas of the multiple-resonance antenna is preferable. In the multiple-resonance antenna adopting capacitance power supply, the impedance for each of the resonance antennas can be controlled relatively easily by controlling the length and width of the gap for capacitance power supply. Therefore, the impedance matching between the resonance antennas is relatively easy.

On the other hand, the gap for capacitance power supply does not exist in the multiple-resonance antenna adopting direct power supply. Therefore, the impedance control for each of the resonance antennas cannot be performed. The impedance matching between the resonance antennas becomes difficult.

An object of the present invention is to provide an antenna device which can realize the impedance matching between resonance antennas of a surface-mounted multiple-resonance antenna of a direct power supply type by a simple configuration, radio communication equipment, a surface-mounted antenna, a printed circuit board, and a manufacturing method of the surface-mounted antenna and the printed circuit board.

An antenna device according to the present invention to achieve the above object includes a substrate having a power supply line and a ground pattern, and a surface-mounted multiple-resonance antenna having a base and a conductor pattern formed on the base and provided on the substrate, wherein the conductor pattern includes plural antenna conductor patterns and a plane conductor pattern which connects each of the antenna conductor patterns and the power supply line, wherein the plane conductor pattern includes a slit which controls the connection distance between at least a portion of each of the antenna conductor patterns and the power supply line, wherein the substrate has a land pattern which connects each of the antenna conductor patterns and the ground pattern and does not have a conductor pattern in a region corresponding to the slit.

The impedance of the resonance antenna varies according to the length of a power supply path to the antenna conductor pattern. According to the present invention, the impedance matching between the resonance antennas of the surface-mounted multiple-resonance antenna of a direct power supply type can be realized by the simple configuration of the slit.

In the antenna device, each of the antenna conductor patterns may include a power supply electrode formed on the side surface of the base, the plane conductor pattern may be formed on the bottom surface of the base and connect the power supply electrode and the power supply line, and the slit may be provided between the power supply line and each of the power supply electrodes. With this, the length of the power supply path to each of the antenna conductor patterns can be controlled by adjusting the depth of the slit.

In the antenna device, each of the plural antenna conductor patterns may include a top surface conductor pattern formed on the top surface of the base, and the conductor pattern may include each conductor pattern provided in the position of the bottom surface of the base opposite each of the top surface conductor patterns. With this, it becomes easier to realize the impedance matching between the resonance antennas.

An antenna device of another aspect of the present invention includes a substrate having a power supply line and a ground pattern, and a surface-mounted multiple-resonance antenna having a base and plural antenna conductor patterns formed on the base and provided on the substrate, wherein the substrate has a land pattern which connects each of the antenna conductor patterns, the power supply line, and the ground pattern, wherein the land pattern includes a slit which controls the connection distance between at least a portion of each of the antenna conductor patterns and the power supply line, wherein the surface-mounted multiple-resonance antenna does not have a conductor pattern on the surface corresponding to the slit. With this, the impedance matching between the resonance antennas of the surface-mounted multiple-resonance antenna of a direct power supply type can be realized by the simple configuration of the slit.

In the antenna device, each of the antenna conductor patterns may include a power supply electrode formed on the side surface of the base, the land pattern may be formed under the base and connect each of the power supply electrodes and the power supply line, and the slit may be provided between the power supply line and the power supply electrode. With this, the length of the power supply path to each of the antenna conductor patterns can be controlled by adjusting the depth of the slit.

Radio communication equipment according to the present invention has at least one of the antenna devices.

A surface-mounted multiple-resonance antenna according to the present invention has a base and a conductor pattern formed on the base and provided on a substrate having a power supply line, wherein the conductor pattern includes plural antenna conductor patterns and a plane conductor pattern which connects each of the antenna conductor patterns and the power supply line, wherein the plane conductor pattern includes a slit which controls the connection distance between at least a portion of each of the antenna conductor patterns and the power supply line.

A printed circuit board according to the present invention has a power supply line and a ground pattern and on which a surface-mounted multiple-resonance antenna having plural antenna conductor patterns formed on a base is provided, and includes a land pattern which connects each of the antenna conductor patterns, the power supply line, and the ground pattern, wherein the land pattern includes a slit which controls the connection distance between at least a portion of each of the antenna conductor patterns and the power supply line.

A manufacturing method of a surface-mounted multiple-resonance antenna according to the present invention has a base and provided on a substrate having a power supply line, wherein a conductor pattern which has plural antenna conductor patterns and a plane conductor pattern which connects each of the antenna conductor patterns and the power supply line and includes a slit which controls the connection distance between at least a portion of each of the antenna conductor patterns and the power supply line is formed on the base.

A manufacturing method of a printed circuit board according to the present invention has a power supply line and a ground pattern and on which a surface-mounted multiple-resonance antenna having plural antenna conductor patterns is provided, wherein a land pattern which connects each of the antenna conductor patterns, the power supply line, and the ground pattern and includes a slit which controls the connection distance between at least a portion of each of the antenna conductor patterns and the power supply line is formed.

According to the present invention, the impedance matching between the resonance antennas of the surface-mounted multiple-resonance antenna of a direct power supply type can be realized by the simple configuration of the slit.

### BRIEF DESCRIPTION OF THE DRAWINGS

FIG. 1A is a perspective view showing the configuration of an antenna device according to a first embodiment of the present invention, and FIG. 1B omits the description of other portions of a surface-mounted antenna so that conductors formed on the bottom surface of the surface-mounted antenna can be easily seen;

FIG. 2 is a developed view of the surface-mounted antenna according to the first embodiment of the present invention;

FIGS. 3A and 3B are plan views showing the configuration of a substrate according to the first embodiment of the present invention, in which FIG. 3A is a plan view of the face side of the substrate (the surface on which the surface-mounted antenna is provided) and FIG. 3B is a plan view of the back side of the substrate;

FIGS. 4A, 4B, 4C, 4D, 4E, and 4F are explanatory views of the relation between the connection distance between each of antenna conductor patterns and a power supply line and the depth of a slit according to the first embodiment of the present invention;

FIGS. 5A, 5B, and 5C are diagrams in which the impedance of each of the antenna conductor patterns for each of the examples shown in FIGS. 4A, 4B, 4C, 4D, 4E, and 4F is measured and is shown on the Smith chart;

FIGS. 6A, 6B, 6C, 6D, 6E, and 6F are diagrams in which a return loss near the resonance frequency of each of the antenna conductor patterns of each of the examples shown in FIGS. 4A, 4B, 4C, 4D, 4E, and 4F is measured and is plotted;

FIGS. 7A and 7B are plan views showing the configuration of the substrate according to a second embodiment of the present invention, in which FIG. 7A is a plan view of the face side of the substrate (the surface on which the surface-mounted antenna is provided) and FIG. 7B is a plan view of the back side of the substrate;

FIG. 8 is a developed view of the surface-mounted antenna according to the second embodiment of the present invention;

FIG. 9 is a developed view of the surface-mounted antenna according to a third embodiment of the present invention; and

FIGS. 10A and 10B are plan views showing the configuration of the substrate according to the third embodiment of the present invention, in which FIG. 10A is a plan view of the face side of the substrate (the surface on which the surface-mounted antenna is provided) and FIG. 10B is a plan view of the back side of the substrate.

### DESCRIPTION OF THE PREFERRED EMBODIMENTS

Preferred embodiments of the present invention will be described below in detail with reference to the accompanying drawings.

### First Embodiment

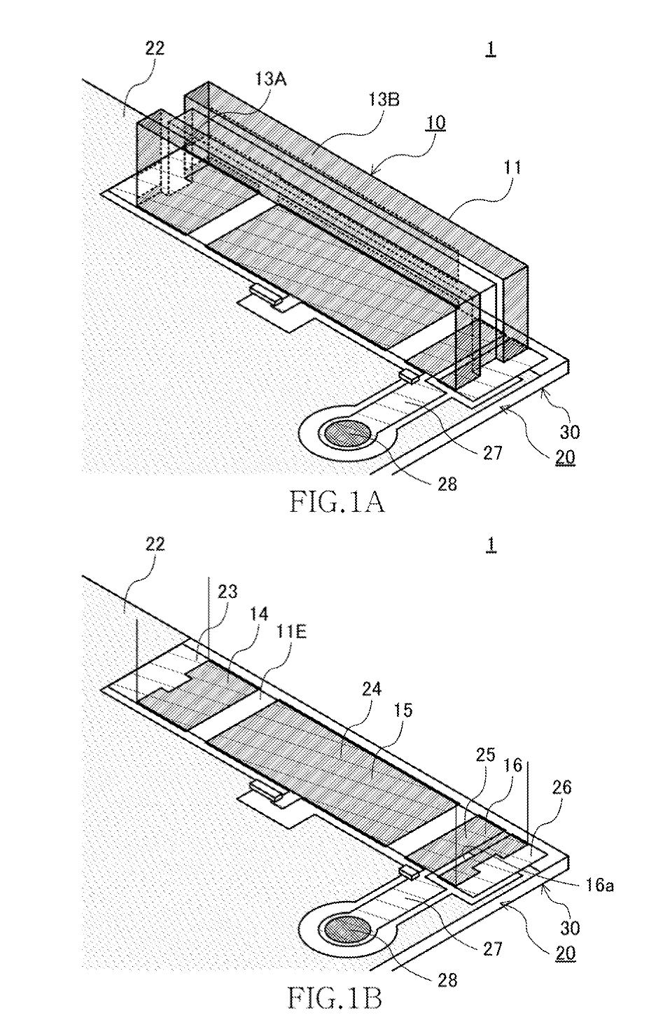

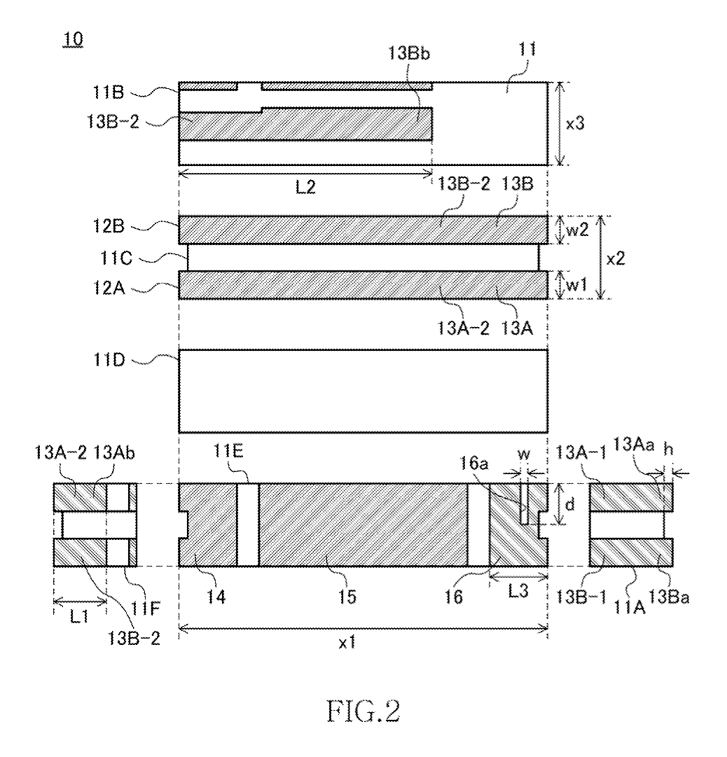

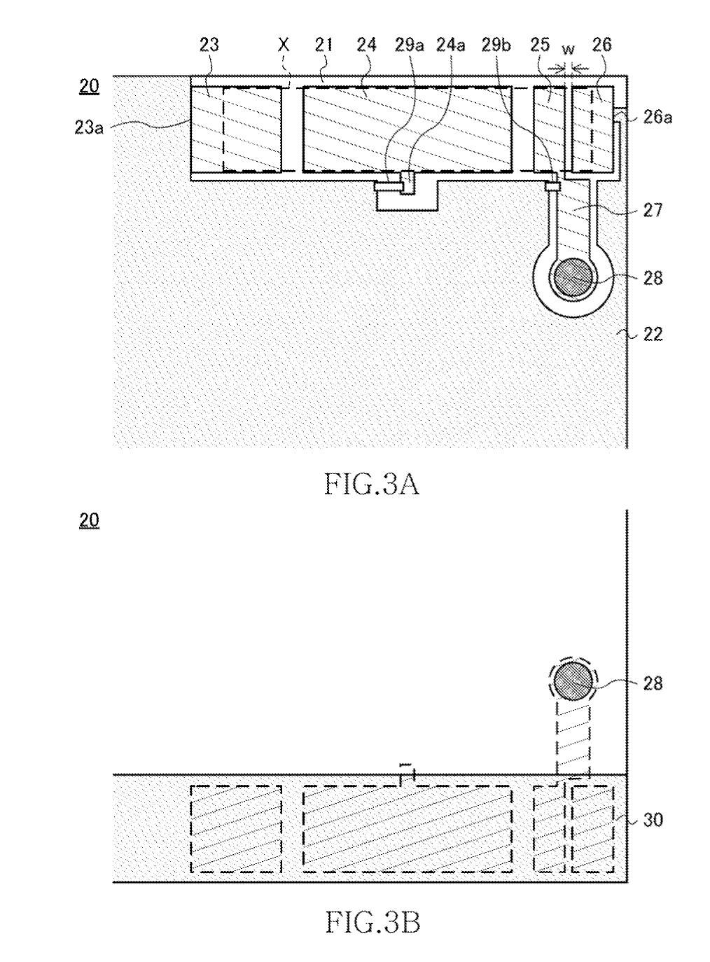

FIG. 1A is a perspective view showing the configuration of an antenna device 1 according to a first embodiment of the present invention. As shown in FIG. 1A, the antenna device 1 has a surface-mounted antenna 10, and a substrate 20 on which the surface-mounted antenna 10 is provided. The antenna device 1 is mounted on compact radio communication equipment such as a cellular phone. FIG. 1B omits the description of other portions of the surface-mounted antenna 10 so that conductors formed on the bottom surface of the surface-mounted antenna 10 can be easily seen. FIG. 2 shows a developed view of the surface-mounted antenna 10. FIGS. 3A and 3B show plan views showing the configuration of the substrate 20. FIG. 3A is a plan view of the face side of the substrate 20 (the surface on which the surface-mounted antenna 10 is provided). FIG. 3B is a plan view of the back side of the substrate 20. The configuration of the antenna device 1 will be described below in detail with reference to these drawings.

As shown in FIGS. 1A, 1B, and 2, the surface-mounted antenna 10 has a base 11 made of a dielectric having a substantially rectangular parallelepiped shape, antenna conductor patterns 13A and 13B and plane conductor patterns 14 to 16 configured by conductors on the surface of the base 11. As shown in FIG. 1A, the surface-mounted antenna 10 is provided near the corner portion of the substrate 20.

The size of the base 11 may be appropriately set according to a target antenna characteristic. Without being limited, lateral lengths x1 and x2 (x1>x2) can be 14 mm and 3 mm, respectively, and a height x3 can be 3 mm. Without being limited, as the materials of the base 11, it is preferable to use dielectric materials such as a Ba—Nd—Ti material (specific inductive capacity of 80 to 120), an Nd—Al—Ca—Ti material (specific inductive capacity of 43 to 46), an Li—Al—Sr—Ti (specific inductive capacity of 38 to 41), a Ba—Ti material (specific inductive capacity of 34 to 36), a Ba—Mg—W material (specific inductive capacity of 20 to 22), an Mg—Ca—Ti material (specific inductive capacity of 19 to 21), sapphire (specific inductive capacity of 9 to 10), alumina ceramics (specific inductive capacity of 9 to 10), and cordierite ceramics (specific inductive capacity of 4 to 6). The base 11 is manufactured by calcining these materials using a die.

The dielectric materials to be specifically used may be appropriately selected according to the used frequencies of the later-described radio communication systems to use the antenna conductor patterns 13A and 13B. As specific inductive capacity ∈r is larger, a higher wavelength shortening effect can be obtained. Therefore, the length of the radiation conductor can be shortened. When the specific inductive capacity ∈r is too large, the antenna gain is reduced. It is preferable to determine the optimum dielectric material by observing the balance of these. By way of example, when the antenna conductor pattern 13A is used for GPS reception and the antenna conductor pattern 13B is used for wireless LAN communication of IEEE 802.11b, it is preferable to use the dielectric material having specific inductive capacity of about 5 to 40. As such dielectric material, the Mg—Ca—Ti dielectric ceramic can be preferably used. As the Mg—Ca—Ti dielectric ceramic, it is particularly preferable to use the Mg—Ca—Ti dielectric ceramic containing TiO₂, MgO, CaO, MnO, and Sio₂.

The term “substantially rectangular parallelepiped shape” is intended to include, not only a complete rectangular parallelepiped, but also a partially incomplete rectangular parallelepiped. In this embodiment, as shown in FIGS. 1A and 2, a groove which penetrates through the center of each of the surfaces at an equal width and a depth h from the lower side of a side surface 11A through a top surface 11C to the lower side of a side surface 11F is cut in the base 11. Thus, a convex surface 12A having a constant width w1 along the boundary between the top surface 110 and a side surface 11D and a convex surface 12B having a constant width w2 along the boundary between the top surface 11C and a side surface 11B are formed. The base 11 does not have the complete rectangular parallelepiped shape. Such groove and convex portions are provided for preferably electrically separating the antenna conductor patterns 13A and 13B.

The antenna conductor pattern 13A is a conductor pattern formed on the convex surface 12A. The formed region of the antenna conductor pattern 13A passes from the lower side of the side surface 11A (of two side surfaces vertical to a longitudinal direction, the side surface near the corner portion of the substrate 20) of the base 11 through the top surface 11C to the position at a distance L1 from the upper side of the side surface 11F (the side surface opposite the side surface 11A), and has a continuous belt-shaped configuration having the constant width w1. The portion of the conductor pattern configuring the antenna conductor pattern 13A provided on the side surface 11A is a power supply electrode 13A-1 and the portion other than that is a radiation electrode 13A-2. One end 13Aa (the end on the power supply electrode 13A-1 side) of the antenna conductor pattern 13A is connected to the plane conductor pattern 16 at the lower end of the side surface 11A. The other end 13Ab (the portion at the distance L1 from the upper side of the side surface 11F) of the antenna conductor pattern 13A is not connected to other conductor patterns.

The antenna conductor pattern 13B has a conductor pattern formed on the convex surface 12B and a conductor pattern formed on the side surface 11B. The former passes from the lower side of the side surface 11A of the base 11 through the top surface 11C to the position at the distance L1 from the upper side of the side surface 11F, and has a continuous belt-shaped configuration having the constant width w2 in parallel with the antenna conductor pattern 13A. The latter has a configuration extended from the conductor pattern of the side surface 11F onto the side surface 11B along a length L2. The portion of the conductor pattern configuring the antenna conductor pattern 13B provided on the side surface 11A is a power supply electrode 13B-1 and the portion other than that is a radiation electrode 13B-2. One end 13Ba (the end on the power supply electrode 13B-1 side) of the antenna conductor pattern 13B is connected to the plane conductor pattern 16 at the lower end of the side surface 11A. The other end 13Bb (the portion at the distance L2 from the boundary between the side surfaces 11B and 11F) of the antenna conductor pattern 13B is not connected to other conductor patterns.

The plane conductor patterns 14 and 16 are conductor patterns having a substantially rectangular shape formed throughout the entire width of a bottom surface 11E at the end on the side surface 11F side and the end on the side surface 11A side in a longitudinal direction of the bottom surface 11E, respectively. The length in a longitudinal direction of the base 11 of the plane conductor pattern 16 is L3. The plane conductor pattern 14 is extended to the side surfaces 11F and 11B and is not connected to the antenna conductor patterns 13A and 13B. As described above, the plane conductor pattern 16 is connected to the power supply electrodes 13A-1 and 13B-2 provided on the side surface 11A.

As shown in FIGS. 1B and 2, the plane conductor pattern 16 has a slit 16a having a width w and a depth d cut from the side surface 11D side. This point will be described in detail later.

The plane conductor pattern 15 is a rectangular conductor pattern formed throughout the entire width of the bottom surface 11E between the plane conductor patterns 14 and 16. The plane conductor pattern 15 is extended to near the boundary between the side surface 11B and the bottom surface 11E. The plane conductor pattern 15 is not contacted with other conductor patterns on the surface of the base 11.

Each of the conductor patterns can be formed by sintering under a predetermined temperature condition after applying a paste material for electrode to the base 11 by screen printing or transfer. As the paste material for electrode, silver, silver-palladium, silver-platinum, and copper can be used. The conductor pattern can also be formed by plating or sputtering.

The slit 16a may be manufactured by providing a shape corresponding to the slit 16a in a plate film used for screen printing or may be manufactured by cutting away the portion corresponding to the slit 16a after the plane conductor pattern 16 not having the slit is formed.

As shown in FIGS. 1A, 1B, 3A, and 3B, the substrate 20 has, on its face side, a ground clearance region 21 not provided with a ground pattern, a ground pattern 22 provided around the ground clearance region 21, land patterns 23 to 26 provided in the ground clearance region 21, a power supply line 27 connected to the land pattern 25, and a throughhole conductor 28 which guides the power supply line 27 to the back side of the substrate 20, and has, on its back side, a ground pattern 30. A region X indicated by the dashed line of the ground clearance region 21 is the provided region of the surface-mounted antenna 10. Although not shown, other various electronic components for configuring radio communication equipment are mounted on the substrate 20.

The ground clearance region 21 is provided along the corner portion of the substrate 20. Two directions around the ground clearance region 21 are surrounded by the ground pattern 22. Other two directions form an open space in which the substrate 20 does not exist.

The ground pattern 30 on the back side also exists immediately below the region X. Therefore, the surface-mounted antenna 10 is of the so-called on-ground type.

The land patterns 23 and 24 are provided in the positions corresponding to the plane conductor patterns 14 and 15 of the surface-mounted antenna 10, respectively, and are solder connected to these conductors. The land pattern 23 is contacted with the ground pattern 22 at an end 23a. A chip reactor 29a for frequency adjustment configured by an inductor, a capacitor, or a short circuit is mounted between the land pattern 24 and the ground pattern 22. The chip reactor 29a is inserted in series between a lead portion 24a of the land pattern 24 and the ground pattern 22. The mounted position of the chip reactor 29a is preferably the position outside the ground clearance region 21 and as closely as possible to the ground clearance region 21.

The land patterns 25 and 26 are provided in the positions corresponding to the plane conductor pattern 16 of the surface-mounted antenna 10 and are solder connected to these conductors. The gap between the land patterns 25 and 26 is set to the constant width w. The position of the gap corresponds to the position of the slit 16a. In other words, the substrate 20 does not have a conductor pattern in a region corresponding to the slit 16a. The land pattern 26 is contacted with the ground pattern 22 at an end 26a.

The power supply line 27 is connected to the land pattern 25. A chip reactor 29b for impedance adjustment configured by an inductor, a capacitor, or a short circuit is mounted between the power supply line 27 and the ground pattern 22. The mounted position of the chip reactor 29b is preferably the position outside the ground clearance region 21 and as closely as possible to the ground clearance region 21. The power supply line 27 is introduced into the back side by the through hole conductor 28 and is connected to a signal line (not shown) on the back side.

Each of the ground patterns and each of the land patterns can be formed by preparing a substrate to which copper foil is stuck on the entire surface and dissolving the copper foil in the unnecessary portion by etching.

The surface-mounted antenna 10 and the substrate have the above configurations. Therefore, the antenna conductor patterns 13A and 13B function as an inverted-F antenna, respectively. That is, in the antenna conductor pattern 13A, the land pattern 26 functions as the short stub of the inverted-F antenna, and the end 13Ab functions as the open end of the inverted-F antenna. In the antenna conductor pattern 138, the land pattern 26 functions as the short stub of the inverted-F antenna and the end 13Bb functions as the open end of the inverted-F antenna.

The resonance frequencies of the antenna conductor patterns 13A and 13B are determined mainly by the length and width of the conductors formed on the surface of the base 11 and the specific inductive capacity of the base 11. In the antenna device 1, fine adjustment of the resonance frequencies is enabled by appropriately adjusting the reactance of the chip reactor 29a.

The antenna conductor pattern 13A relatively located inside the substrate 20 is preferably used for the radio communication system of a relatively high frequency. The antenna conductor pattern 13B relatively located outside the substrate 20 is preferably used for the radio communication system of a relatively low frequency. By way of example, when they cope with GPS reception using a frequency in a 1.5 GHz bandwidth and IEEE 802.11b communication using a frequency in a 2.5 GHz bandwidth, it is preferable that the resonance frequency of the antenna conductor pattern 13A be adjusted to the 2.5 GHz bandwidth and that the resonance frequency of the antenna conductor pattern 13B be adjusted to the 1.5 GHz bandwidth.

The slit 16a provided in the plane conductor pattern 16 will be described.

By the above configurations, an electric current input from the power supply line 27 enters the plane conductor pattern 16 through the land pattern 25, and reaches each of the power supply electrodes 13A-1 and 13B-1 beyond the slit 16a. The slit 16a is provided between the power supply line 27 and each of the power supply electrodes 13A-1 and 13A-2. By the depth d of the slit 16a, the connection distance between the antenna conductor patterns 13A and 13B and the power supply line can be controlled. This will be specifically described below.

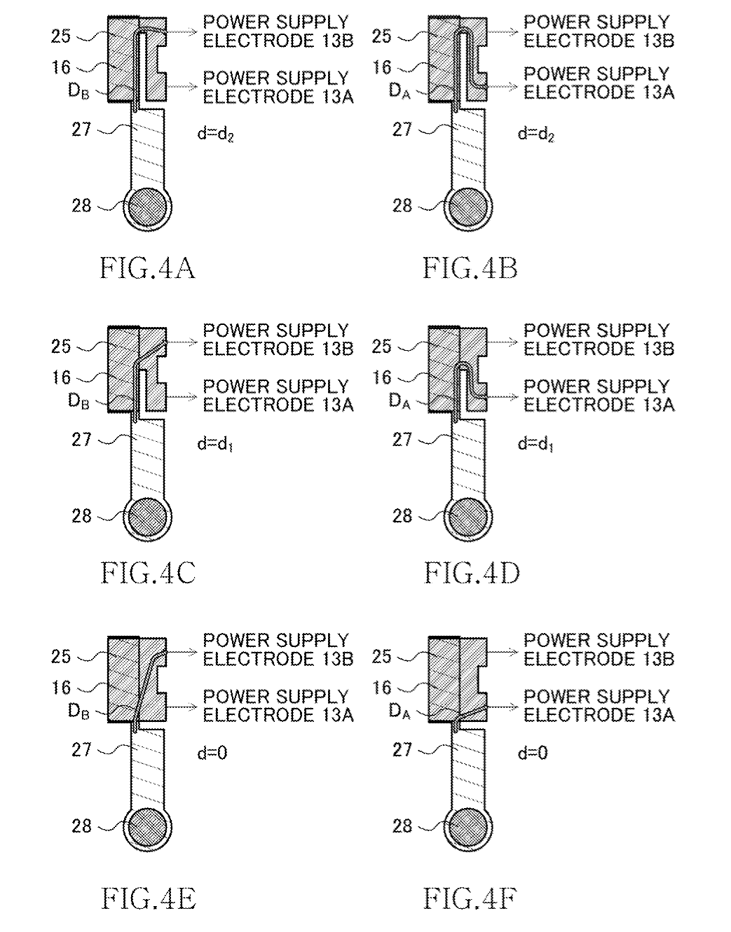

FIGS. 4A, 4B, 4C, 4D, 4E, and 4F are explanatory views of the relation between the connection distance between the antenna conductor patterns 13A or 13B and the power supply line 27 and the depth d of the slit 16a. In FIGS. 4A and 4B, d=d₂, in FIGS. 4C and 4D, d=d₁ (0<d₁<d₂), and in FIGS. 4E and 4F, d=0. The position of the end 26a is fixed.

As shown in FIGS. 4B, 4D, and 4F, as the depth d is larger, a path (power supply path) D_{A} of an electric current from the power supply line 27 to the power supply electrode 13A is longer. This is because the electric current goes around the slit 16a.

As shown in FIGS. 4A, 4C, and 4E, as the depth d is larger, a path D_{B} of an electric current from the power supply line 27 to the power supply electrode 13B is also longer. The power supply electrode 13B is substantially opposite the power supply line 27 across the depth direction of the slit 16a, so the amount in change is smaller than that of the path D_{A}.

Thus, when the position of the end 26a is fixed, the difference between the paths D_{B} and D_{A} can be controlled by changing the depth. This means that the difference in impedance between the antenna conductor patterns 13A and 13B can be controlled. When the depth d is adjusted to a suitable value in the manufacturing stage, the impedance matching between the resonance antennas can be simply realized.

The effect of the present invention will be described below by giving specific measured results. In the examples shown below, x1=14 mm, x2=3 mm, x3=3 mm, w1=1 mm, w2=1 mm, L1=2 mm, L2=10 mm, L3=2.5 mm, d₁=1.5 mm, and d₂=2.5 mm. The resonance frequency of the antenna conductor pattern 13A is adjusted to the 2.5 GHz bandwidth. The resonance frequency of the antenna conductor pattern 13B is adjusted to the 1.5 GHz bandwidth.

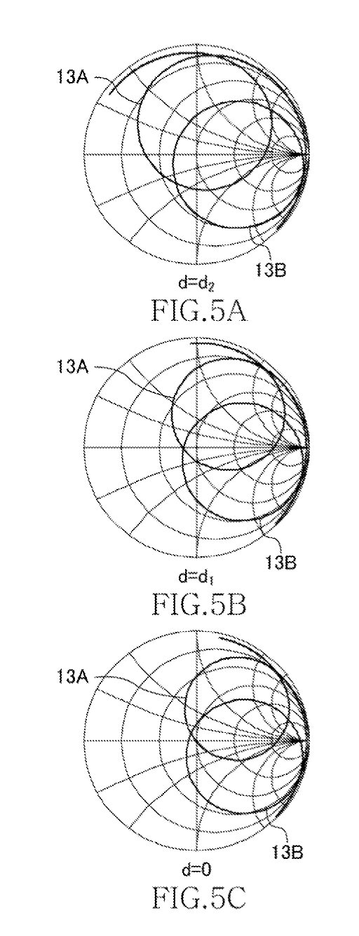

FIGS. 5A, 5B, and 5C are diagrams in which the impedance of each of the antenna conductor patterns 13A and 13B for each of the examples of the depth d shown in FIGS. 4A, 4B, 4C, 4D, 4E, and 4F is measured and is shown on the Smith chart. FIGS. 5A, 5B, and 5C correspond to d=d_{Z}, d₁, and 0, respectively. In the Smith chart, the center indicates a reference characteristic impedance (e.g., 50Ω), the right end indicates impedance infinity (open), and the left end indicates impedance 0 (short circuit). A positive reactance is taken clockwise of the upper half portion. A negative reactance is taken counterclockwise of the lower half portion.

When the frequency is increased from 0 Hz, the impedance of each of the antenna conductor patterns 13A and 13B is traced as shown in the Smith chart of FIGS. 5A, 5B, and 5C. As is apparent from FIGS. 5A, 5B, and 5C, the impedance characteristic of the antenna conductor pattern 13B is hardly changed according to the depth d. However, the impedance characteristic of the antenna conductor pattern 13A is largely changed according to the depth d. This shows that the impedance of the antenna conductor pattern 13A is particularly controlled by the control of the depth d of the slit 16a.

Of the three examples of the depth d shown in FIGS. 5A, 5B, and 5C, the example of d=d₁ shown in FIG. 5B shows that the difference in curvature of a curve showing the change in impedance between the antenna conductor patterns 13A and 13B is minimum. It means the impedance matching between the antenna conductor patterns 13A and 13B can be taken best when d=d₁. Therefore, it is most preferable that the depth c of the slit 16a be d₁, not 0 or d₂.

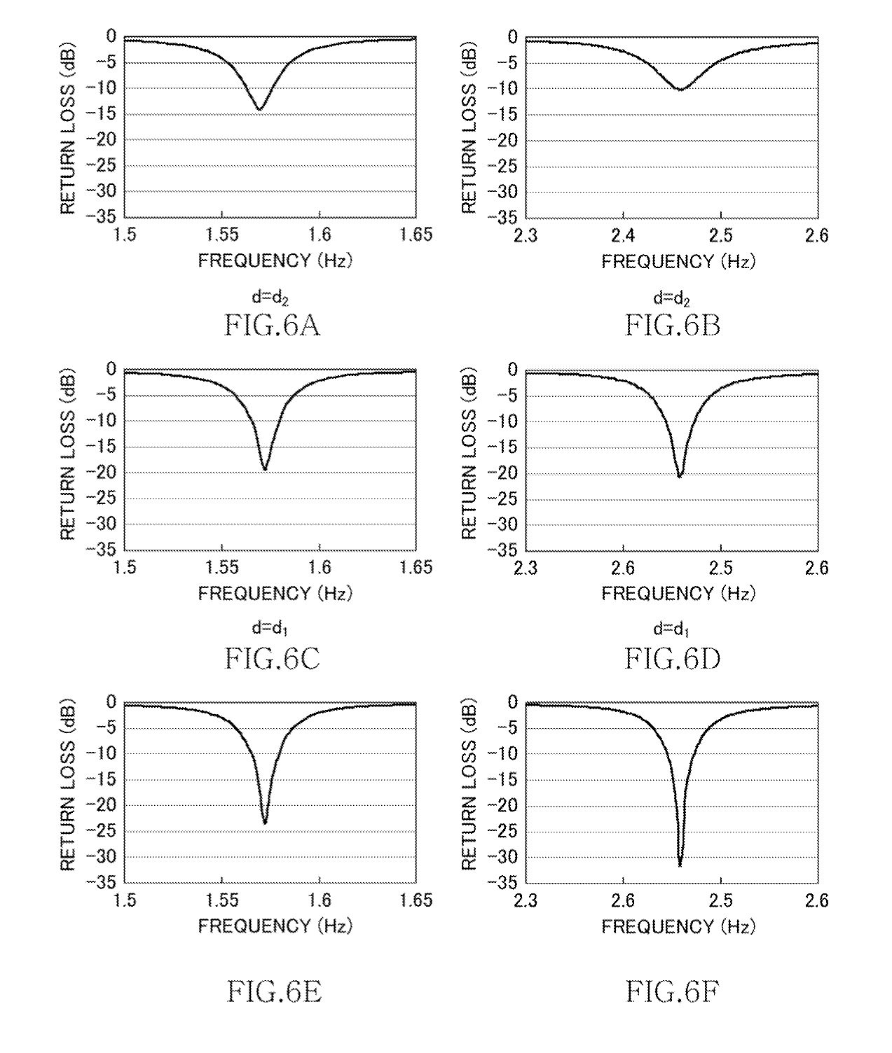

FIGS. 6A, 6B, 6C, 6D, 6E, and 6F are diagrams in which a return loss near the resonance frequency of each of the antenna conductor patterns 13A and 13B of each of the examples of the depth d shown in FIGS. 4A, 4B, 4C, 4D, 4E, and 4F is measured and is plotted. FIGS. 6A, 6C, and 6E show a return loss near the resonance frequency in the 1.5 GHz bandwidth of the antenna conductor pattern 13B. FIGS. 6B, 6D, and 6F show a return loss near the resonance frequency in the 2.5 GHz bandwidth of the antenna conductor pattern 13A. FIGS. 6A and 6B correspond to d=d₂, FIGS. 6C and 6D correspond to d=d₁, and FIGS. 6E and 6F correspond to d=0.

As is apparent from FIGS. 6A, 6B, 6C, 6D, 6E, and 6F, the return losses are changed according to the depth d of the slit 16a in both the 1.5 GHz bandwidth and the 2.5 GHz bandwidth. The magnitude of the change in the 2.5 GHz bandwidth is larger. That is, the difference in impedance between the antenna conductor patterns 13A and 13B is controlled by the control of the depth d of the slit 16a.

Of the three examples of the depth d shown in FIGS. 6A, 6B, 6C, 6D, 6E, and 6F, the examples of d=d₁ shown in FIGS. 6C and 6D show that the difference in the return loss is minimum. It means the impedance matching between the antenna conductor patterns 13A and 13B can be taken best when d=d₁. As a result, it is most preferable that the depth d of the slit 16a be d₁, not 0 or d₂.

The specific value of the depth d is changed due to various factors of the material, shape, and size of the base 11, the conductor patterns, and the substrate 20, and other elements provided on the substrate 20 and is preferably determined by an experiment for each type of a product.

As described above, according to the antenna device 1 of this embodiment, the length of the power supply path to each of the antenna conductor patterns can be controlled by adjusting the depth d of the slit 16a. Therefore, the impedance matching between the resonance antennas can be realized by the simple configuration of the slit 16a.

### Second Embodiment

The antenna device 1 according to this embodiment is the same as the first embodiment except for the position providing the slit. In the first embodiment, the slit is provided in the conductor pattern formed on the surface of the surface-mounted antenna 10. In this embodiment, the slit is provided in the land pattern formed on the surface of the substrate 20. Focusing on this difference, this embodiment will be described below in detail.

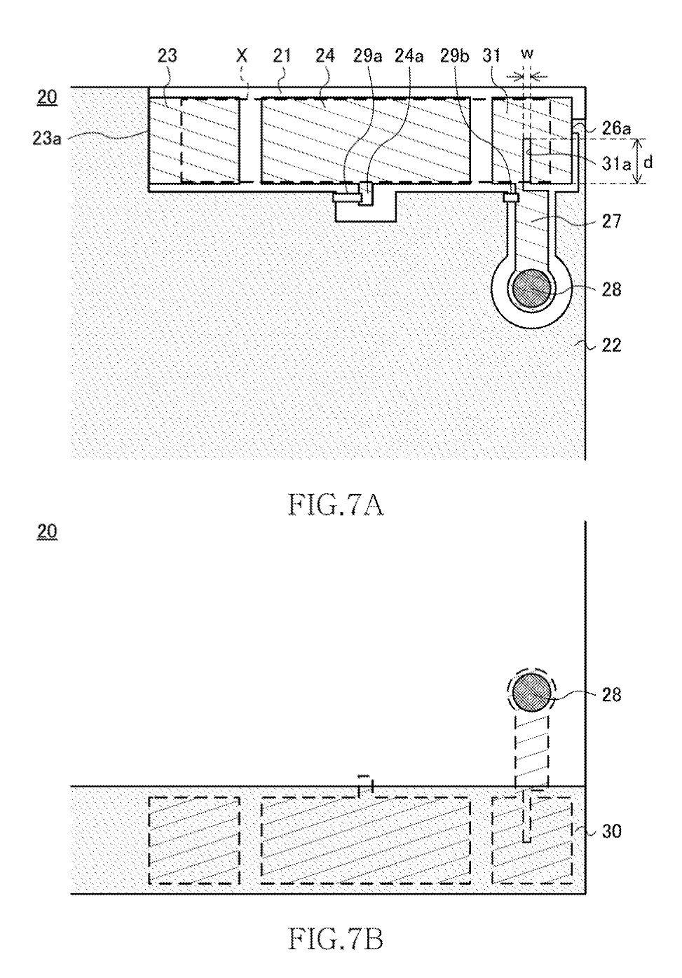

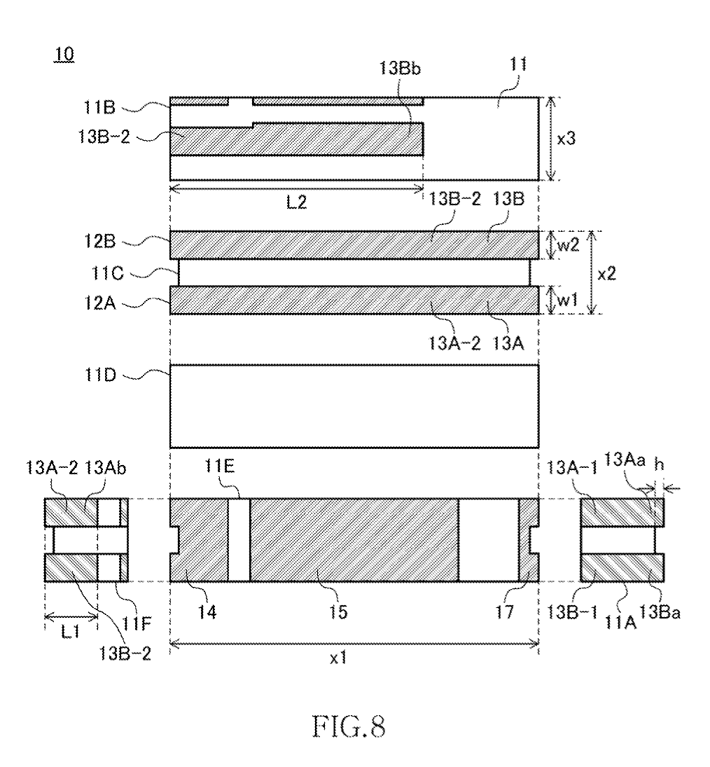

FIGS. 7A and 7B are plan views showing the configuration of the substrate 20 according to this embodiment. FIG. 8 is a developed view of the surface-mounted antenna 10 according to this embodiment.

As shown in FIG. 7A, the substrate 20 according to this embodiment has a land pattern 31 in place of the land patterns 25 and 26 shown in FIG. 3. The land pattern 31 has a shape in which the gap portion between the land patterns 25 and 26 is filled with the conductor pattern and has a slit 31a having the width w and the depth d cut from the power supply line 27 side in the portion corresponding to the gap.

The slit 31a may be manufactured by providing a shape corresponding to the slit 31a in a mask used for etching copper foil stuck onto the substrate or may be manufactured by cutting away the portion corresponding to the slit 31a after the land pattern 31 not having the slit is formed.

As shown in FIG. 8, the surface-mounted antenna 10 according to this embodiment has a plane conductor pattern 17 in place of the plane conductor pattern 16. The plane conductor pattern 17 is a substantially rectangular conductor pattern formed throughout the entire width of the bottom surface 11E at the end on the side surface 11A side in a longitudinal direction of the bottom surface 11E, and has a shape in which only the portion on the side surface 11A side from the slit 16a is cut out from the plane conductor pattern 16 shown in FIG. 2. The surface-mounted antenna 10 does not have the conductor pattern in the position corresponding to the slit 31a.

By the above configuration, an electric current input from the power supply line 27 passes through the land pattern 31 beyond the slit 31a to the plane conductor pattern 17. The slit 31a is provided between the power supply line 27 and each of the power supply electrodes 13A-1 and 13A-2, as in the slit 16a according to the first embodiment. As in the first embodiment, the connection distance between the antenna conductor patterns 13A and 13B and the power supply line 27 is controlled according to the depth d of the slit 31a.

As described above, according to the antenna device 1 of this embodiment, the length of the power supply path to each of the antenna conductor patterns can be controlled by adjusting the depth d of the slit 31a. Therefore, the impedance matching between the resonance antennas can be realized by the simple configuration of the slit 31a.

Also, since the slit is provided in the substrate 20 side, as compared with the case in which the slit is provided in the surface-mounted antenna 10, the slit can be formed at high accuracy.

### Third Embodiment

This embodiment is the same as the first embodiment except for the specific configuration of the plane conductor pattern 15. Focusing on this difference, this embodiment will be described below in detail.

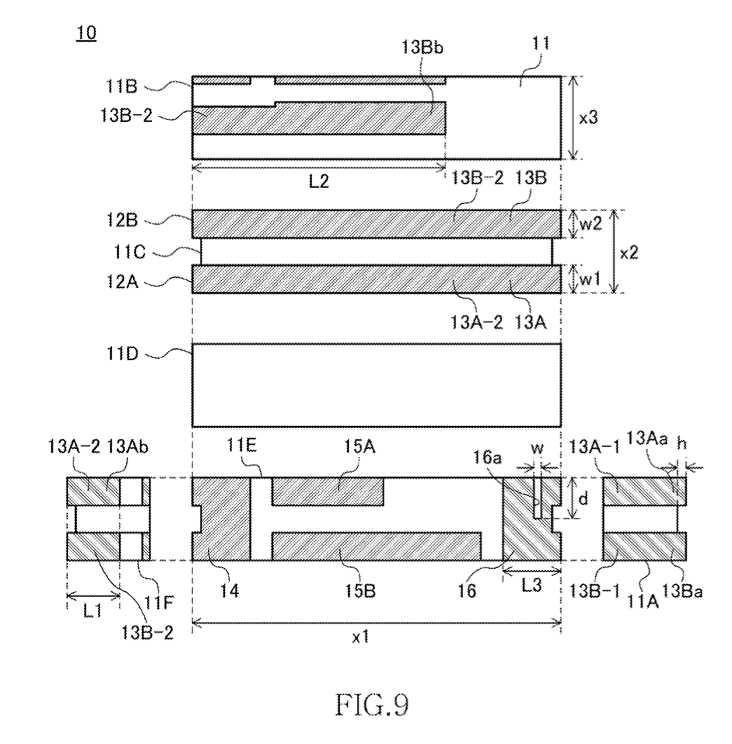

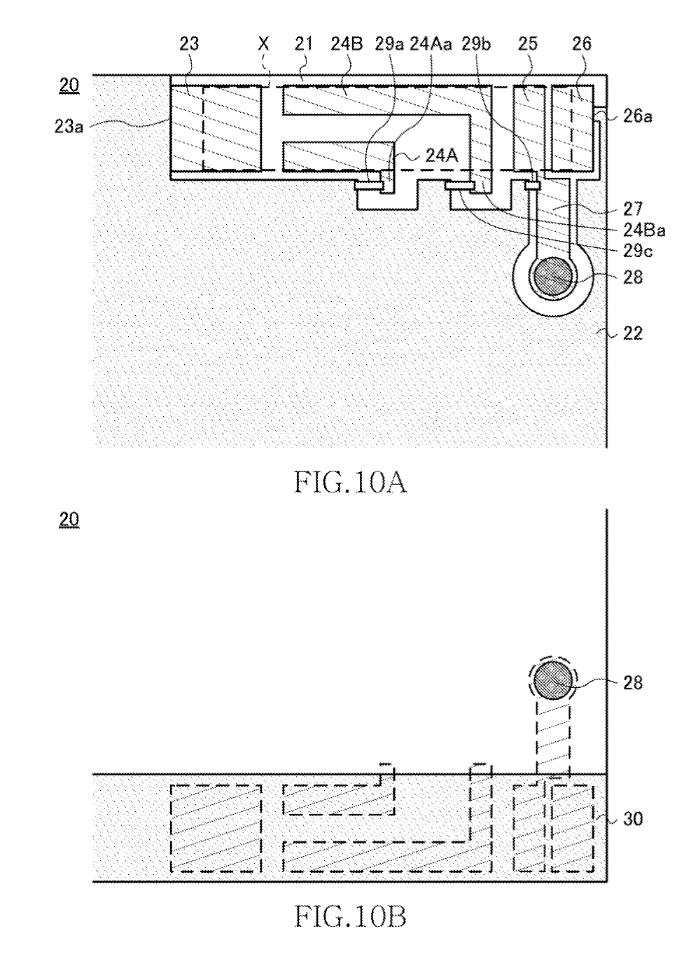

FIG. 9 is a developed view of the surface-mounted antenna 10 according to this embodiment. FIGS. 10A and 10B are plan views showing the configuration of the substrate 20 according to this embodiment.

As shown in FIG. 9, the surface-mounted antenna 10 according to this embodiment has plane conductor patterns 15A and 15B in the portion having the plane conductor pattern 15 in the first embodiment (the bottom surface 11E of the base 11). The plane conductor pattern 15A has the same width as that of the antenna conductor pattern 13A, and is provided in the position opposite the portion provided on the top surface 11C of the antenna conductor pattern 13A (top surface conductor pattern). The plane conductor pattern 15B has the same width as that of the antenna conductor pattern 13B, and is provided in the position opposite the portion provided on the top surface 11C of the antenna conductor pattern 13B (top surface conductor pattern).

As shown in FIG. 10A, the substrate 20 has land patterns 24A and 24B in place of the land pattern 24. Of these, the land pattern 24A is provided in the position corresponding to the plane conductor pattern 15A of the surface-mounted antenna 10 and is solder connected to the plane conductor pattern 15A. The land pattern 248 is provided in the position corresponding to the plane conductor pattern 15B of the surface-mounted antenna 10 and is solder connected to the plane conductor pattern 15B.

A chip reactor 29a for frequency adjustment is mounted between the land pattern 24A and the ground pattern 22. The chip reactor 29a is inserted in series between a lead portion 24Aa of the land pattern 24A and the ground pattern 22. Similarly, a chip reactor 29c for frequency adjustment is mounted between the land pattern 24B and the ground pattern 22. The chip reactor 29c is inserted in series between a lead portion 24Ba of the land pattern 24B and the ground pattern 22.

By the above configuration, the characteristic of the antenna conductor pattern 13A and the characteristic of the antenna conductor pattern 13B can be easily controlled independently. Therefore, the impedance matching between the resonance antennas can be realized more easily.

By way of example, in FIG. 10A, the land patterns 24A and 24B are connected to the ground pattern 22 via the chip reactors for adjusting different frequencies (the chip reactors 29a and 29c). The frequency can be adjusted for each of the antenna conductor patterns.

The preferred embodiments of the present invention have been described above. The present invention is not limited to such embodiments at all. Needless to say, the present invention can be embodied in various forms in the scope without departing from its purport.

What is claimed is:

1. An antenna device comprising:
a substrate having a power supply line and a ground pattern; and
a surface-mounted multiple-resonance antenna having a base and a conductor pattern formed on the base and provided on the substrate, wherein
the conductor pattern comprises plural antenna conductor patterns and a plane conductor pattern which connects each of the antenna conductor patterns and the power supply line, wherein
the plane conductor pattern comprises a slit which controls the connection distance between at least a portion of each of the antenna conductor patterns and the power supply line, wherein
the substrate has a land pattern which connects each of the antenna conductor patterns and the ground pattern and does not have a conductor pattern in a region corresponding to the slit.

2. The antenna device as claimed in claim 1, wherein
each of the antenna conductor patterns comprises a power supply electrode formed on the side surface of the base,
the plane conductor pattern is formed on the bottom surface of the base and connects the power supply electrode and the power supply line, and
the slit is provided between the power supply line and each of the power supply electrodes.

3. The antenna device as claimed in claim 1, wherein
each of the plural antenna conductor patterns comprises a top surface conductor pattern formed on the top surface of the base, and
the conductor pattern comprises each conductor pattern provided in the position of the bottom surface of the base opposite each of the top surface conductor patterns.

4. An antenna device comprising:
a substrate having a power supply line and a ground pattern, and
a surface-mounted multiple-resonance antenna having a base and plural antenna conductor patterns formed on the base and provided on the substrate, wherein
the substrate has a land pattern which connects each of the antenna conductor patterns, the power supply line, and the ground pattern, wherein
the land pattern comprises a slit which controls the connection distance between at least a portion of each of the antenna conductor patterns and the power supply line, wherein
the surface-mounted multiple-resonance antenna does not have a conductor pattern on the surface corresponding to the slit.

5. The antenna device as claimed in claim 4, wherein
each of the antenna conductor patterns comprises a power supply electrode formed on the side surface of the base,
the land pattern is formed under the base and connects each of the power supply electrodes and the power supply line, and
the slit is provided between the power supply line and the power supply electrode.

6. Radio communication equipment comprising an antenna device comprising:
a substrate having a power supply line and a ground pattern; and
a surface-mounted multiple-resonance antenna having a base and a conductor pattern formed on the base and provided on the substrate, wherein
the conductor pattern comprises plural antenna conductor patterns and a plane conductor pattern which connects each of the antenna conductor patterns and the power supply line, wherein
the plane conductor pattern comprises a slit which controls the connection distance between at least a portion of each of the antenna conductor patterns and the power supply line, wherein
the substrate has a land pattern which connects each of the antenna conductor patterns and the ground pattern and does not have a conductor pattern in a region corresponding to the slit.

7. Radio communication equipment comprising an antenna device comprising:
a substrate having a power supply line and a ground pattern, and
a surface-mounted multiple-resonance antenna having a base and plural antenna conductor patterns formed on the base and provided on the substrate, wherein
the substrate has a land pattern which connects each of the antenna conductor patterns, the power supply line, and the ground pattern, wherein
the land pattern comprises a slit which controls the connection distance between at least a portion of each of the antenna conductor patterns and the power supply line, wherein
the surface-mounted multiple-resonance antenna does not have a conductor pattern on the surface corresponding to the slit.

8. A surface-mounted multiple-resonance antenna comprising:
a base and a conductor pattern formed on the base, wherein
the surface-mounted multiple-resonance antenna is provided on a substrate having a power supply line,
the conductor pattern comprises plural antenna conductor patterns and a plane conductor pattern which connects each of the antenna conductor patterns and the power supply line, wherein
the plane conductor pattern comprises a slit which controls the connection distance between at least a portion of each of the antenna conductor patterns and the power supply line.

9. A printed circuit board comprising:
a power supply line and a ground pattern, wherein
a surface-mounted multiple-resonance antenna having plural antenna conductor patterns formed on a base is provided on the printed circuit,
the printed circuit further comprising:
a land pattern which connects each of the antenna conductor patterns, the power supply line, and the ground pattern, wherein
the land pattern comprises a slit which controls the connection distance between at least a portion of each of the antenna conductor patterns and the power supply line.

10. A manufacturing method of a surface-mounted multiple-resonance antenna having a base and provided on a substrate having a power supply line, wherein
a conductor pattern which has plural antenna conductor patterns and a plane conductor pattern which connects each of the antenna conductor patterns and the power supply line and includes a slit which controls the connection distance between at least a portion of each of the antenna conductor patterns and the power supply line is formed on the base.

11. A manufacturing method of a printed circuit board having a power supply line and a ground pattern and on which a surface-mounted multiple-resonance antenna having plural antenna conductor patterns is provided, wherein
a land pattern which connects each of the antenna conductor patterns, the power supply line, and the ground pattern and includes a slit which controls the connection distance between at least a portion of each of the antenna conductor patterns and the power supply line is formed.
